(19) United States
(12) Patent Application Publication
(10) Pub. No.: US 2025/0201872 A1
(43) Pub. Date: Jun. 19, 2025

(54) UNIT CELL OF A FUEL CELL STACK AND A MANUFACTURING METHOD THEREOF

(71) Applicants: HYUNDAI MOTOR COMPANY, Seoul (KR); KIA CORPORATION, Seoul (KR)

(72) Inventor: Seong Il Heo, Seongnam-si (KR)

(73) Assignees: HYUNDAI MOTOR COMPANY, Seoul (KR); KIA CORPORATION, Seoul (KR)

(21) Appl. No.: 18/658,738

(22) Filed: May 8, 2024

(30) Foreign Application Priority Data
Dec. 14, 2023 (KR) 10-2023-0181907

(51) Int. Cl. H01M 8/0286; H01M 8/0206; H01M 8/0258; H01M 8/04007; H01M 8/1004; H01M 8/2483

(52) U.S. Cl. CPC H01M 8/0286; H01M 8/0206; H01M 8/0258; H01M 8/04007; H01M 8/1004; H01M 8/2483

(57) ABSTRACT

A method of manufacturing a unit cell for a fuel cell stack includes an operation of preparing a separator and an operation of inputting the prepared separator into a mold and forming a protrusion that protrudes toward one side of the separator at a point thereof.

### CROSS-REFERENCE TO RELATED APPLICATION(S)

This application is based on and claims priority under 35 U.S.C. 119 to Korean Patent Application No. 10-2023-0181907, filed on Dec. 14, 2023, in the Korean Intellectual Property Office, the disclosure of which is herein incorporated by reference in its entirety.

### BACKGROUND

### 1. Field of the Disclosure

The present disclosure relates to a unit cell of a fuel cell stack and to a manufacturing method of a unit cell of a fuel cell stack.

### 2. Description of the Prior Art

A fuel cell is an energy device that produces electric power through a reaction between hydrogen and oxygen in the air. The fuel cell produces electric power through a fuel cell stack. The fuel cell is a collection of unit cells and each of the unit cells is configured by a combination of a membrane electrode assembly, a gas diffusion layer combined to both surfaces of the membrane electrode assembly, and cathode and anode separators combined to respective surfaces of the membrane electrode assembly, to which the gas diffusion layer is combined.

A fuel cell stack is acquired by stacking and combining multiple unit cells generated in this way. However, stacking unit cells may cause a cathode or anode separator to have separator deformation at some points thereof due to a load of the fuel cell stack. More particularly, stacking unit cells may be more problematic as support of a gasket may not be sufficient at some points of the separators where the reaction gas flows in and flows out.

The foregoing described as the background art is intended merely to aid in understanding the background of the present disclosure. The foregoing is not intended to mean that the present disclosure falls within the purview of the related art already known to those having ordinary skill in the art.

### SUMMARY

In accordance with aspects of the present disclosure, a unit cell of a fuel cell stack and a method of manufacturing a unit cell for a fuel cell stack are provided to minimize deformation of a separator even when stacking and combining unit cells.

A unit cell of a fuel cell stack according to the present disclosure includes a membrane electrode assembly (MEA) and a first separator combined to the MEA. The first separator has one surface combined to the MEA and configuring a reaction surface on which a reaction gas flows. The first separator also has another surface configuring a cooling surface on which a cooling medium flows and has gaskets injection-molded on each of the one surface and the other surface. The unit cell also includes a second separator having one surface combined to the other surface of the first separator to configure a cooling surface on which a cooling medium flows. The second separator also has a protrusion that protrudes toward the other surface side of the first separator at a point thereof to pressurize, i.e., press or apply pressure to, a gasket injection-molded on the other surface of the first separator.

A second gasket may be injection-molded on another surface of the second separator and a protrusion may be configured on a point having no second gasket thereon.

Multiple inflow/outflow holes through which a reaction gas flows in or flows out may be configured through the second separator. The second gasket may be configured adjacent to a second inflow/outflow hole through another surface of the second separator. A protrusion may be configured on a point through which each of the second inflow/outflow holes is located and on which no second gasket is injection-molded.

The first separator may include multiple inflow/outflow holes configured therethrough, through which a reaction gas flows in or flows out. The first separator may also include a (1-1)th gasket injection-molded adjacent to a first inflow/outflow hole on one surface thereof and a (1-2)th gasket injection-molded to surround a first inflow/outflow hole on the other surface thereof.

The protrusion of the second separator may be configured at a point corresponding to the point at which the (1-2)th gasket is injection-molded so that the protrusion may pressurize, i.e., press or apply pressure to, the (1-2)th gasket.

The first separator may have multiple first inflow/outflow holes configured therethrough through which a reaction gas flows in or flows out. The second separator may have multiple second inflow/outflow holes configured at points that deviate from the first inflow/outflow holes and configured to cause a reaction gas to flow in or flow out therethrough. The protrusion may be configured at points of the second separator corresponding to points through which the first inflow/outflow holes are configured or at points adjacent to points through which the second inflow/outflow holes are configured.

The protrusion may be configured without a gap with the second inflow/outflow holes.

The protrusion may have an arch shape.

Assuming that a width of the protrusion is W and a radius of a circle having the protrusion as an arc included in the circle is R, W≤R≤5W may be satisfied.

The first separator or the second separator may have multiple reaction gas manifolds configured therethrough for allowing a reaction gas to flow in.

A method of manufacturing a unit cell for a fuel cell stack according to the present disclosure includes an operation of preparing a separator, i.e., a second separator and an operation of inputting the prepared separator into a mold and forming a protrusion that protrudes toward one side of the separator at a point thereof.

The mold used in the operation of forming the protrusion may include a gasket injection mold for injection of a gasket on another surface of the separator. The protrusion may be formed, and the gasket may be injection-molded on the other surface of the separator concurrently in the operation of forming the protrusion.

The protrusion may be formed to have an arch shape.

Assuming that a width of the protrusion is W and a radius of a circle having the protrusion as an arc included in the circle is R, W≤R≤5W may be satisfied.

In a case that the second separator manufactured according to the method of manufacturing a unit cell for a fuel cell stack is applied, the deformation of a separator within the fuel cell may be minimized. Furthermore, a space for a point through which a reaction gas flows in or flows out may be additionally secured so as to increase the water discharge capability.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates a unit cell configuring a fuel cell stack;

FIG. 2 is an exploded perspective view illustrating a unit cell of a fuel cell stack based on a first separator;

FIG. 3 is a sectional view of a unit cell in FIG. 2 taken along line A-A′;

FIG. 4 illustrates unit cells partially stacked to help understand the present disclosure;

FIG. 5 illustrates one surface configuring a reaction surface of a first separator, the other surface configuring a cooling surface thereof, and one surface configuring a reaction surface of a second separator;

FIG. 6 is a sectional view taken along line C-C′ of FIG. 5;

FIG. 7 illustrates a method of manufacturing a unit cell for a fuel cell stack according to an embodiment of the present disclosure;

FIG. 8 illustrates forming a protrusion on a second separator and injection molding a gasket; and

FIG. 9 illustrates combining a first separator and a second separator.

### DETAILED DESCRIPTION OF EMBODIMENTS

Hereinafter, embodiments disclosed in the present specification are described in detail with reference to the accompanying drawings. The same or similar elements are given the same and similar reference numerals throughout the written description and drawings. Thus, duplicate descriptions thereof have been omitted.

In describing the embodiments disclosed in the present specification, where the detailed description of the relevant known technology was determined to unnecessarily obscure the gist of the present disclosure, the detailed description has been omitted. Furthermore, the accompanying drawings are provided only to aid in understanding the embodiments disclosed in the present specification. The technical spirit disclosed herein is not limited to the accompanying drawings. It should be understood that all changes, equivalents, or substitutes to the disclosed embodiments are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

A singular expression may include a plural expression unless the context indicates otherwise.

As used herein, the expressions “comprise”, “include”, or “have” and variations thereof are intended to specify the existence of mentioned features, numbers, steps, operations, elements, components, or combinations thereof. These expressions should not be construed as precluding the possible existence or addition of one or more other features, numbers, steps, operations, elements, components, or combinations thereof.

In the case where an element is referred to as being “connected” or “coupled” to any other element, it should be understood that another element may be provided therebetween, as well as that the element may be directly connected or coupled to the other element. In contrast, in the case where an element is referred to as being “directly connected” or “directly coupled” to any other element, it should be understood that no other element is present therebetween.

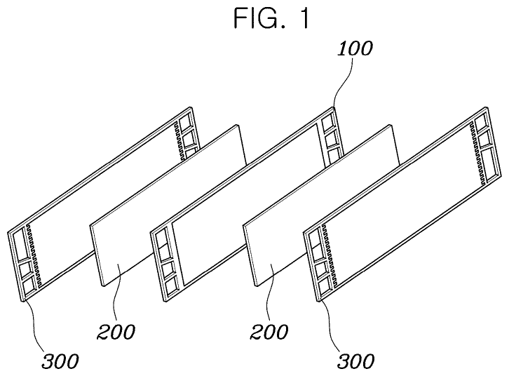

FIG. 1 illustrates a unit cell for configuring a fuel cell stack. The unit cell of a fuel cell stack is described with reference to FIG. 1. The unit cell of a fuel cell stack is configured by combining a pair of gas diffusion layers 200 and a pair of separators 300 based on a membrane electrode assembly 100 as described above.

The unit cell of a fuel cell stack in a conventional sense is as described above, but in the present disclosure, the unit cell of a fuel cell stack is described based on a first separator 400.

In other words, a structure acquired by combining the membrane electrode assembly 100 and a second separator 500 to the first separator configures the unit cell according to the present disclosure.

The gas diffusion layer is combined to the membrane electrode assembly but corresponds to a component combined to a portion forming an electrode. When describing the embodiments of the present disclosure, the gas diffusion layer is not of high importance and thus a description thereof has been omitted.

Furthermore, the first separator 400 and the second separator are components of the present disclosure, may be cathode separators or anode separators. The reaction gas may refer to either or both air (oxygen therein) and hydrogen but is not limited thereto.

The first separator 400 or the second separator 500 may be configured by a metal material and may be configured by a metal material including iron, titanium, aluminum, or the like.

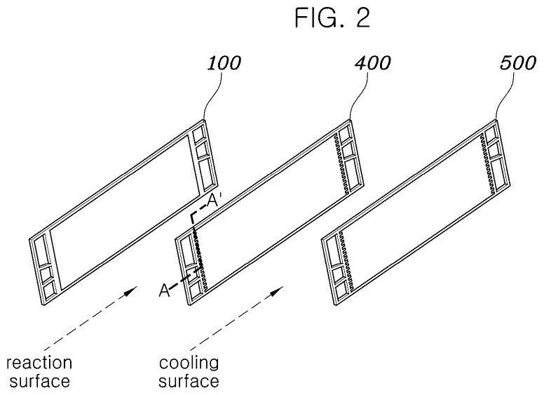

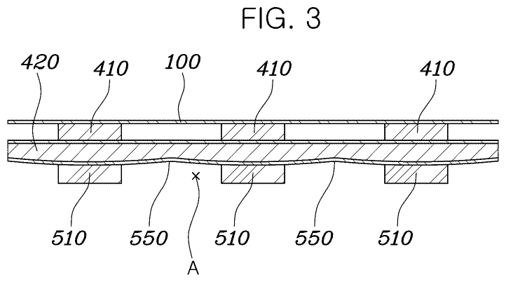

FIG. 2 is an exploded perspective view illustrating a unit cell of a fuel cell stack based on a first separator. FIG. 3 is a sectional view of a unit cell in FIG. 2 taken along line A-A′.

Referring to FIGS. 2 and 3, the unit cell of a fuel cell stack according to the present disclosure includes a membrane electrode assembly (MEA), a first separator 400, and a second separator 500.

The MEA 100 is combined to one surface of the first separator 400. Accordingly, the one surface of the first separator 400 configures or forms a reaction surface on which a reaction gas flows. Here, a gasket 410 is injection-molded on the one surface of the first separator 400. The injection-molded gasket 410 supports the MEA 100 as shown in FIG. 3 and prevents the reaction gas flowing on the reaction surface from flowing out to the outside.

One surface of the second separator 500 is combined to the other surface of the first separator 400 to configure or form a cooling surface on which a cooling medium flows. Specifically, when an electrochemical reaction of the reaction gas occurs in a fuel cell stack, electricity, by-products, and heat from the exothermic reaction are generated. In order for the fuel cell stack to operate in an optimal temperature range, continuous cooling of the fuel cell stack is required. To this end, a cooling surface on which a cooling medium flows is configured or formed in the unit cell of the fuel cell stack.

Referring to FIG. 3, a gasket 420 is injection-molded on the other surface of the first separator 400 as well. In other words, the gasket 420 is injection-molded on the other surface of the first separator 400 to prevent the cooling medium flowing on the cooling surface from flowing out to the outside while supporting the second separator 500.

Meanwhile, a protrusion 550 that protrudes toward the other surface side, i.e., the cooling surface side of the first separator 400 is configured at a point on the second separator 500. The protrusion pressurizes, i.e., presses or applies pressure to, the gasket 420 injection-molded on the other surface of the first separator 400 as shown in FIG. 3.

As shown in FIG. 3, the protrusion 550 configured on the second separator 500 allows an additional space on the other surface of the second separator 550, which configures the reaction surface. Thus, water discharge capability may be increased.

In addition, in the case of the second separator 500, if the protrusion 550 is not configured at a point (indicated by point A in FIG. 3) on which a gasket is not configured, a phenomenon of separator deformation occurs, in which the separator sags downward compared to the surrounding area.

The protrusion 550 is configured on the second separator 500 as in the present disclosure to pressurize the gasket 420 configured on the other surface of the first separator 400, stronger than in a conventional design, thereby showing an effect of suppressing deformation of the separator at the same point.

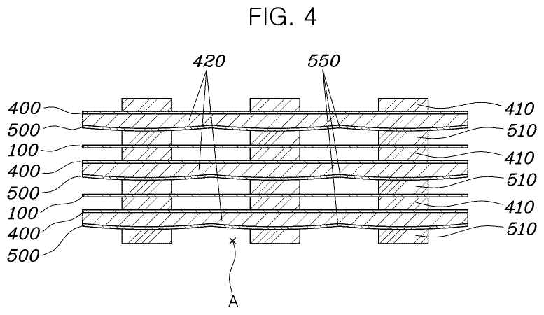

FIG. 4 illustrates unit cells partially stacked to help understand the present disclosure. Referring to FIG. 4, it may be identified that one surface of the first separator 400 and the other surface of the second separator 500 each are combined to the MEA 100 to configure a reaction surface. The other surface of the first separator 400 and the one surface of the second separator 500 are combined to each other to configure a cooling surface.

Meanwhile, a second gasket 510 may be injection-molded on the other surface of the second separator 500 configuring the reaction surface. The second gasket 510 prevents the reaction gas flowing on the reaction surface from flowing out to the outside and supports a surface pressure applied from the first separator 400 to the second separator 500.

Meanwhile, as shown in FIGS. 3 and 4, the protrusion 550 may be configured at a point A on which the second gasket 510 is not injection-molded. The second gasket 510 may have a discontinuous shape so that the second gasket 510 is not configured at a point, specifically, through which the reaction gas flows in or flows out so as to prevent the reaction gas from flowing out to the outside and thus to cause the reaction gas to smoothly flows into the reaction surface.

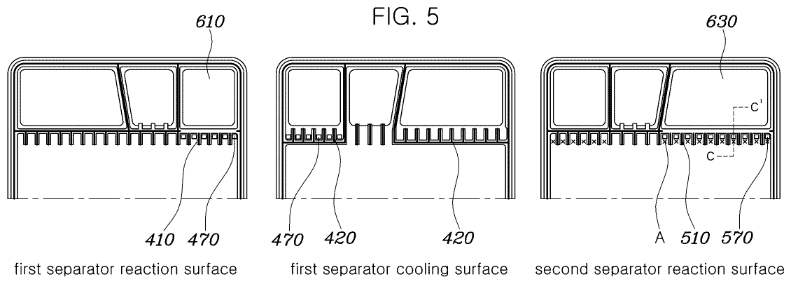

An injection formation location of the second gasket 510 and a location of the protrusion 550 within the second separator 500 are described in detail below. FIG. 5 illustrates one surface configuring a reaction surface of a first separator 400, the other surface configuring a cooling surface thereof. FIG. 5 also illustrates the other surface configuring a reaction surface of a second separator.

Multiple second inflow/outflow holes 570 through which the reaction gas flows in or flows out are configured or formed through the second separator 500. A reaction gas manifold 630 for allowing the reaction gas to flow into the reaction surface may be configured on the second separator 500. The reaction gas may flow into the reaction surface via a second inflow/outflow hole 570 through the reaction gas manifold 630.

Meanwhile, the second gasket 510 needs to prevent the reaction gas from flowing out to the outside while allowing the reaction gas to smoothly flow into or out of the reaction surface. Thus, the second gasket 510 is injection-molded adjacent to the second inflow/outflow hole 570 but the second gasket 510 is not injection-molded at a location at which the second inflow/outflow hole 570 is located.

In other words, the second gasket 510 extends along a direction in which the second inflow/outflow hole 570 is configured. However, the second gasket 510 is not injection-molded at a location at which the second inflow/outflow hole 570 is configured and the protrusion 550 may be configured at the corresponding location.

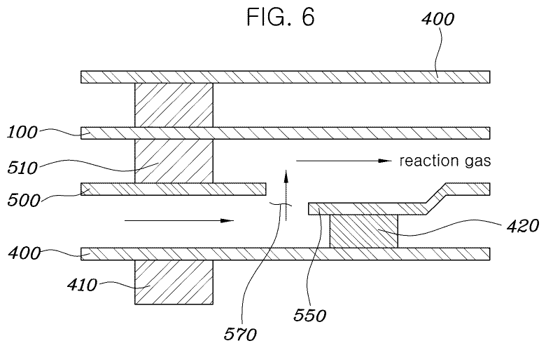

More specifically, FIG. 6 is a sectional view taken along line C-C′ of FIG. 5. Referring to FIG. 6, it may be identified that the second gasket 510 is configured adjacent to the second inflow/outflow hole 570. Also, the second gasket 510 is not injection-molded at a location at which the second inflow/outflow hole 570 is located. Further, the protrusion 550 protrudes toward the other surface of the first separator 400 at the corresponding point.

Here, the protrusion 550 may be configured without a gap with the second inflow/outflow hole 570. In a case that the protrusion 550 is configured to be spaced a predetermined distance away from the second inflow/outflow hole 570, rather, a flow of the reaction gas is interrupted due to bending of the position where the protrusion 550 is configured and more defective products may occur when manufacturing the second separator 500.

Accordingly, in one example, the protrusion 550 is configured without a gap with the second inflow/outflow hole 570.

Referring to FIG. 5, multiple first inflow/outflow holes 470 through which the reaction gas flows in and flows out may be configured or formed through the first separator 400 as well. In addition, a reaction gas manifold 610 for allowing the reaction gas to flow into the reaction surface may be configured on the second separator 400. The reaction gas may flow into the reaction surface via a first inflow/outflow hole 470 through the reaction gas manifold 610.

A (1-1)th gasket 410 may be injection-molded to be adjacent to the first inflow/outflow hole 470 on one surface of the first separator 400. A (1-2)th gasket 420 may be injection-molded to surround the first inflow/outflow hole on the other surface of the first separator 400.

As in the case of the second gasket 510, the (1-1)th gasket 410 is injection-molded to be adjacent to the first inflow/outflow hole 470, but the (1-1)th gasket 410 is not injection-molded at a point where the first inflow/outflow hole 470 is located. On the other hand, the (1-2)th gasket 420 prevents the reaction gas from flowing into the cooling surface and is configured to have a continuous shape so as to surround the first inflow/outflow hole 470.

Meanwhile, referring to FIG. 5, the protrusion 550 of the second separator 500 may be configured at a point corresponding to a point where the (1-2)th gasket 420 is injection-molded so that the protrusion 550 may pressurize the (1-2)th gasket 420. The point where the protrusion 550 is configured within the second separator 550 is shown in FIG. 5.

To summarize the above, the protrusion 550 may be configured within the second separator 500 and, specifically, may be configured at a point where the second inflow/outflow hole 570 is configured within the second separator 500 or at a point where the first inflow/outflow hole 470 is configured within the first separator 400. Here, the first inflow/outflow hole 470 and the second inflow/outflow hole 570 may be configured at points that deviate from each other so that the protrusion 550 may be configured at the point A shown in FIG. 5.

The protrusion 550 may have an arch shape. Specifically, assuming that a width of the protrusion 550 is W and a radius of a circle having the protrusion 550 as an arc included in the circle is R, W≤R≤5W may be satisfied.

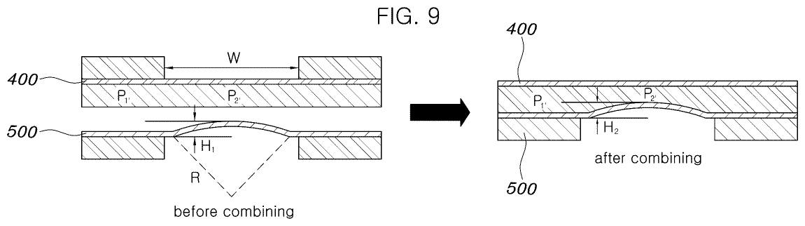

Referring to FIG. 9, assuming that a radius of a circle having the arch of the protrusion 550 as an arc is R and a width of the protrusion 550 is W, in one example 2W≤R≤4W.

If R>5W, a height of the protrusion 550 is too low to sufficiently pressurize the (1-2)th gasket 420. Thus, the compensation effect for surface pressure is insufficient, and it is difficult to configure an arch shape.

Meanwhile, if R<W, the height of the protrusion 550 is too high. Thus, it is difficult to secure a sufficient thickness of the (1-2)th gasket 420 at a point corresponding to the protrusion 550 of the second separator 500.

In an example, W may be a width of the protrusion or may be a distance between adjacent (1-1)th gaskets or a distance between adjacent (1-2)th gaskets.

Hereinafter, a method of manufacturing a unit cell for a fuel cell stack is described. The method is used to manufacture the second separator 500 in which the protrusion 550 is configured to pressurize a gasket formed on the first separator 400.

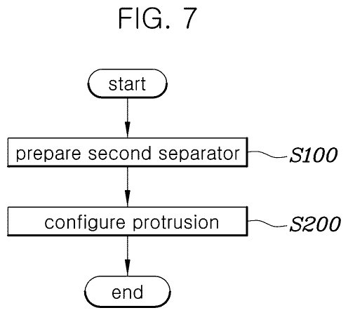

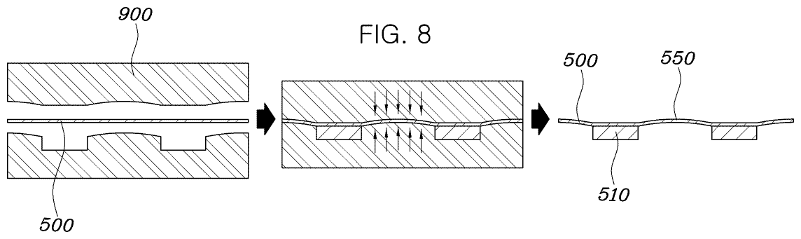

FIG. 7 illustrates a method of manufacturing a unit cell for a fuel cell stack according to an embodiment of the present disclosure. FIG. 8 illustrates forming a protrusion on a second separator and injection molding a gasket.

A method of manufacturing a unit cell for a fuel cell stack according to the present disclosure includes an operation S100 of preparing a separator, i.e. the second separator. The method also includes an operation S200 of inputting the prepared separator into a mold and forming a protrusion that protrudes toward the other side of the separator at a point thereof.

The mold 900 used in the operation S200 of forming the protrusion includes a gasket injection mold 900 for injection of the gasket 510 on the other surface of the second separator 500. The gasket injection mold 900 may have a curved shape at some points to configure the protrusion 550 and the gasket injection mold 900 may pressurize the second separator 500 to form the protrusion 550 on the second separator 500.

Concurrently, the gasket 510 may be injection-molded on a surface, i.e., the other surface, of the second separator 500.

FIG. 9 illustrates combining of a first separator 400 and a second separator 500. Referring to FIG. 9, the protrusion 550 formed on the second separator 500 pressurizes the (1-2)th gasket 420 of the first separator 400 to acquire a relationship of H1>H2 as a height of the protrusion 550 is reduced.

Assuming that in the first separator 400 and the second separator 500, a pressure above the gasket supports is P1′ and a pressure between the gasket supports is P2′, the pressure P1′ and pressure P2′ before combining the first separator 400 and the second separator 500 are identical to each other. However, after combining the first separator 400 and the second separator 500, P1′ and P2′ may be approximated to each other. In other words, compared to a conventional case in which no protrusion was configured on the second separator and where P1′, which receives a surface pressure from the second gasket, always has a larger value than P2′, when using the second separator with the protrusion configured thereon according to the present disclosure, P1′ and P2′ have approximate values so that the surface pressure becomes uniform. Further, over-compression at specific points may be prevented when unit cells are stacked and combined.

As the unit cell of the fuel cell stack is used, the critical airtight pressure of the fuel cell stack may be increased and the airtight durability may be increased.

Although the present disclosure has been described and illustrated in conjunction with particular embodiments thereof, it should be apparent to those having ordinary skill in the art that various improvements and modifications may be made to the embodiments without departing from the technical idea of the present disclosure defined by the appended claims.

What is claimed is:

1. A unit cell of a fuel cell stack, the unit cell comprising:
a membrane electrode assembly (MEA);
a first separator combined to the MEA, the first separator having one surface combined to the MEA and configuring a reaction surface on which a reaction gas flows, having another surface configuring a cooling surface on which a cooling medium flows, and having gaskets injection-molded on each of the one surface and the other surface; and
a second separator having one surface combined to the other surface of the first separator to configure a cooling surface on which a cooling medium flows and having a protrusion that protrudes toward the other surface side of the first separator at a point thereof to pressurize a gasket injection-molded on the other surface of the first separator.

2. The unit cell of claim 1, wherein a second gasket is injection-molded another surface of the second separator and wherein a protrusion is configured on a point having no second gasket thereon.

3. The unit cell of claim 1, wherein:
multiple second inflow/outflow holes through which a reaction gas flows in or flows out are configured through the second separator;
the second gasket is injection-molded adjacent to each of the second inflow/outflow holes through another surface of the second separator; and
a protrusion is configured on a point through which each of the second inflow/outflow holes is located and on which no second gasket is injection-molded.

4. The unit cell of claim 1, wherein the first separator comprises:
multiple first inflow/outflow holes configured therethrough and through which a reaction gas flows in or flows out;
a (1-1)th gasket injection-molded adjacent to each of the first inflow/outflow holes on one surface thereof; and
a (1-2)th gasket injection-molded to surround each of the first inflow/outflow holes on the other surface thereof.

5. The unit cell of claim 4, wherein the protrusion second separator is configured at a point of the corresponding to the point at which the (1-2) gasket is injection-molded so that the protrusion pressurizes the (1-2)th gasket.

6. The unit cell of claim 1, wherein:
the first separator comprises multiple first inflow/outflow holes configured therethrough and through which a reaction gas flows in or flows out;
the second separator comprises multiple second inflow/outflow holes configured at points which deviate from the first inflow/outflow holes and configured to cause a reaction gas to flow in or flow out therethrough; and
the protrusion is configured at a point of the second separator corresponding to each of points through which the first inflow/outflow holes are configured or at a point adjacent to each of points through which the second inflow/outflow holes are configured.

7. The unit cell of claim 6, wherein the protrusion is configured without a gap with each of the second inflow/outflow holes.

8. The unit cell of claim 1, wherein the protrusion has an arch shape.

9. The unit cell of claim 8, wherein, where a width of the protrusion is W and a radius of a circle having the protrusion as an arc included in the circle is R, W≤R≤5W is satisfied.

10. The unit cell of claim 1, wherein the first separator or the second separator is configured by a metal material.

11. The unit cell of claim 1, wherein the first separator or the second separator has multiple reaction gas manifolds configured therethrough to allow a reaction gas to flow in.

12. A method of manufacturing a unit cell for a fuel cell stack, the method comprising:
preparing a separator; and
inputting the prepared separator into a mold and forming a protrusion that protrudes toward one side of the separator at a point thereof.

13. The method of claim 12, wherein:
the mold used in forming the protrusion corresponds to a gasket injection mold for injection of a gasket on another surface of the separator; and
in forming the protrusion, the protrusion is formed and the gasket is injection-molded on another surface of the separator concurrently.

14. The method of claim 12, wherein the protrusion is formed to have an arch shape.

15. The method of claim 14, wherein, where a width of the protrusion is W and a radius of a circle having the protrusion as an arc included in the circle is R, W≤R≤5W is satisfied.
